(19) United States
(12) Patent Application Publication
(10) Pub. No.: US 2004/0011898 A1
(43) Pub. Date: Jan. 22, 2004

(54) Fuel-injection and a method for setting the same

(76) Inventor: Heinz Luft, Hirschaid (DE)

Correspondence Address: KENYON & KENYON, ONE BROADWAY, NEW YORK, NY, 10004, US

(21) Appl. No.: 10/362,084

(22) PCT Filed: May 7, 2002
(86) PCT No.: PCT/DE02/01643

(30) Foreign Application Priority Data
Jun. 22, 2001 (DE) 101 30 239.8

(51) Int. Cl. B05B 1/30

(52) U.S. Cl. 239/585.1

(57) ABSTRACT

A fuel injector (1) for fuel-injection systems of internal combustion engines, especially for the direct injection of fuel into the combustion chamber of an internal combustion engine, comprising an actuator (10); a valve needle (3) which is in operative connection to the actuator (10) and acted upon by a restoring spring (23) in a closing direction, to actuate a valve-closure member (4) which forms a sealing seat together with a valve-seat surface (6); and an adjustment sleeve (24), which provides the restoring spring (23) with an initial stress. The adjustment sleeve (24) has a cup-shaped design and an eccentric bore (38) in a base (37), which is in variable alignment with an eccentric bore (36) in a base (35) of a likewise cup-shaped inner sleeve (34) able to be inserted into the adjustment sleeve (24).

### BACKGROUND INFORMATION

The present invention starts out from a fuel injector according to the definition of the species in claim 1, and from a method for adjusting a fuel injector according to the definition of the species in claim 9.

A method for adjusting a fuel injector, as well as a fuel injector are known from DE 40 23 828 A1. To adjust the flow quantity of a medium released during the opening and closing process of an electromagnetically actuable fuel injector, a magnetically conductive material is introduced into a blind-end bore, in powder form, for instance, the material being able to change the magnetic properties of the inner pole, thereby varying the magnetic force, until the measured actual flow rate of the medium corresponds to the predefined setpoint quantity.

In a similar manner, it is proposed in DE 40 23 826 A1 to insert an adjusting bolt into a blind-end bore of an inner pole provided with an opening at its periphery, and thereby vary the magnetic force. The adjusting bolt is inserted so far that the measured actual quantity conforms to the predefined setpoint quantity.

From DE 195 16 513 A1 as well, a method is known for adjusting the flow rate of a dynamic medium of a fuel injector. In this case, an adjusting element positioned near the magnetic coil, outside the flow route of the medium, is adjusted, causing a change in the magnitude of the magnetic flow in the magnetic circuit and, thus, in the magnetic force, so that the flow rate of the medium is able to be influenced and adjusted. The adjustment may be carried out both in a wet and a dry fuel injector.

DE 42 11 723 A1 proposes a fuel injector and a method for adjusting the flow rate of a dynamic medium of a fuel injector. In this case, an adjustment sleeve, having a longitudinal slit, is pressed into a longitudinal bore of a connecting piece up to a predefined pressing depth, the valve's instantaneous quantity of a dynamic medium is measured and compared to a setpoint quantity of the medium, and the pressed-in adjustment sleeve, which is under a tension acting in the radial direction, is advanced until the measured instantaneous quantity of the medium conforms to the predefined setpoint quantity of the medium.

In DE 44 31 128 A1, to adjust the flow rate of a dynamic medium of a fuel injector, a deformation of the valve housing takes place by a deformation tool engaging on the outer circumference of the valve housing. In the process, the size of the residual-air gap between the core and the armature and, thus, the magnitude of the magnetic force, changes, so that the flow rate of the medium is able to be influenced and adjusted.

Particularly disadvantageous in the group of methods, which influence the magnitude of the magnetic flow in the magnetic circuit, is the high production cost, since the required static flow-rate tolerances must be assured, which is difficult to realize, however. Especially the measurements of the magnetic fields are costly and, in most cases, require cost-intensive methods and also a testing field.

Disadvantageous in the group of mechanical adjustment methods, in particular, is the high imprecision to which these methods are subject. Furthermore, the opening and closing times of a fuel injector can only be shortened at the expense of the electric output, thereby increasing the electrical load of the components and placing greater demands on the control devices.

Especially the method known from DE 44 31 128 A1, in which the residual-air gap between the core and armature is modified by deformation of the valve housing, is unable to correct the flow rate with high precision, since shear stresses in the nozzle body influence the direction and magnitude of the deforming force in a disadvantageous manner. For this reason, all parts require high manufacturing precision.

### SUMMARY OF THE INVENTION

In contrast, the fuel injector according to the present invention having the characterizing features of claim 1, and the method of the present invention having the characterizing features of claim 9, have the advantage over the related art that eccentric bores in the bases of the adjustment sleeve and in the inner sleeve inserted therein, to adjust the dynamic flow rate according to the desired fuel quantity, may be brought into varying degrees of alignment for a resulting diaphragm-cross section, without influencing the adjustment of the static flow, or vice versa.

The features set forth in the dependent claims allow advantageous developments of the fuel injector recited in claim 1 and the method recited in claim 9.

Furthermore, it is advantageous that the adjustment sleeve and the inner sleeve are able to be produced in an uncomplicated and inexpensive manner.

The inner sleeve is advantageously held in place in the adjustment sleeve by a spring ring, thereby avoiding an adjustment of the inner sleeve and, thus, a change in the resulting diaphragm cross-section during operation of the fuel injector. In this manner, the static flow rate is reliably adjusted.

It is particularly advantageous that the method steps for adjusting the dynamic and the static flow are able to be executed in any order, depending on the given installation possibilities.

Especially advantageous is the possibility of increasing the static flow rate from a preset mean diaphragm cross-section up to an unthrottled maximum value, by increasing the diaphragm cross-section, and of decreasing it to approximately zero by reducing the diaphragm cross-section.

### BRIEF DESCRIPTION OF THE DRAWINGS

An exemplary embodiment of the present invention is represented in the drawing in simplified form and explained in greater detail in the following description.

The figures show:

FIG. 1 a schematic section through an exemplary embodiment of a fuel injector configured according to the present invention, in an overall view;

FIG. 2 an excerpt of a schematic section through the exemplary embodiment, shown in FIG. 1, of a fuel injector designed according to the present invention, in region II in FIG. 1; and

FIG. 3 an excerpt of a schematic cross-section through the adjustment sleeve of the fuel injector designed according to the present invention, along the line III-III in FIG. 2.

### DESCRIPTION OF THE EXEMPLARY EMBODIMENT

An exemplary embodiment of a fuel injector 1 according to the present invention is designed in the form of a fuel injector 1 for fuel-injection systems of mixture-compressing internal combustion engines having externally supplied ignition. Fuel injector 1 is particularly suited for the direct injection of fuel into a combustion chamber (not shown) of an internal combustion engine.

Fuel injector 1 is made up of a nozzle body 2 in which a valve needle 3 is positioned. Valve needle 3 is in operative connection with a valve-closure member 4, which cooperates with a valve-seat surface 6, located on a valve-seat member 5, to form a sealing seat. In the exemplary embodiment, fuel injector 1 is an inwardly opening fuel injector 1, which has one spray-discharge orifice 7. Seal 8 seals nozzle body 2 from an outer pole 9 of a magnetic coil 10. Magnetic coil 10 is encapsulated in a coil housing 11 and wound on a coil brace 12, which rests against an inner pole 13 of magnetic coil 10. Inner pole 13 and outer pole 9 are separated from each other by a constriction 26 and are interconnected by a non-ferromagnetic connecting part 29. Magnetic coil 10 is energized via a line 19 by an electric current, which may be supplied via an electrical plug contact 17. A plastic coating 18, which may be extruded onto inner pole 13, encloses plug contact 17.

Valve needle 3 is guided in a valve-needle guide 14, which is disk-shaped. A paired adjustment disk 15 is used to adjust the (valve) lift. An armature 20 is on the other side of adjustment disk 15. It is connected by force-locking to valve needle 3 via a first flange 21; and valve needle 3 is connected to first flange 21 by a welded seam 22. Braced against first flange 21 is a restoring spring 23 which, in the present design of fuel injector 1, is prestressed by a sleeve 24.

The position of adjustment sleeve 24 is responsible for the initial stress of restoring spring 23 and, thus, for the dynamic flow rate through fuel injector 1. The higher the initial stress of restoring spring 23, the longer it takes when current is supplied to magnetic coil 10 for the magnetic field to be strong enough to pull armature 20 to inner pole 13, counter to the spring force of restoring spring 23.

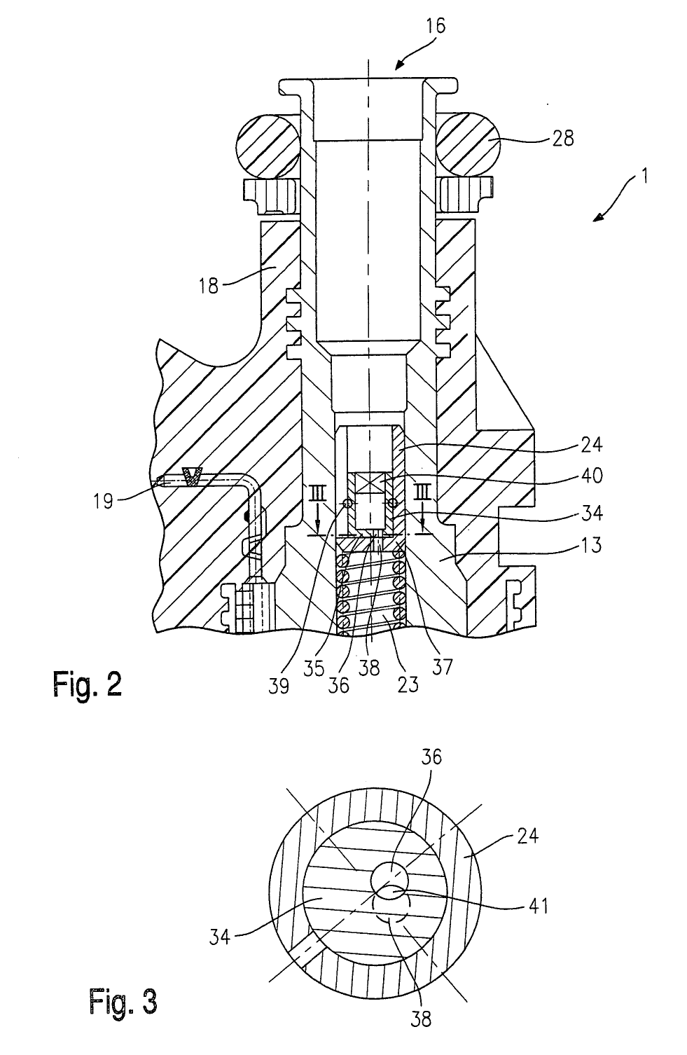

To adjust the static flow rate through fuel injector 1, the present invention provides for an inner sleeve 34, which is inserted into adjustment sleeve 24. Inner sleeve 34 is cup-shaped and has an eccentric bore 36 in a base 35 of inner sleeve 34. Adjustment sleeve 24 also has a cup-shaped design and is likewise provided with an eccentric bore 38 in a base 37 of adjustment sleeve 24. Eccentric bores 36 and 38 are configured such that they are able to be brought into alignment. A detailed description of the measures according to the present invention and the functioning method of inner sleeve 34 can be inferred from FIGS. 2 and 3 and the following description.

Fuel channels 30a through 30c run in valve-needle guide 14, in armature 20 and valve-seat member 5. The fuel is supplied via a central fuel feed 16 and filtered by a filter element 25. Seal 28 seals fuel injector 1 from a fuel line (not shown further).

On the spray-discharge side of armature 20 is an annular damping element 32 made of an elastomeric material. It rests on a second flange 31, which is joined to valve needle 3 by force-locking via a welded seam 33.

In the rest state of fuel injector 1, armature 20 is acted upon by restoring spring 23, in a direction opposite to its lift direction, in such a manner that valve-closure member 4 is sealingly held against valve seat 6. In response to excitation of magnetic coil 10, it generates a magnetic field, which moves armature 20 in the lift direction, counter to the spring force of restoring spring 23, the lift being predefined by a working gap 27, which occurs in the rest position between inner pole 12 and armature 20. First flange 21, which is welded to valve needle 3, is also taken along by armature 20 in the lift direction. Valve-closure member 4, which is connected to valve needle 3, lifts off from valve seat surface 6, so that the fuel is spray-discharged through spray-discharge orifice 7.

In response to interruption of the coil current, following sufficient decay of the magnetic field, armature 20 falls away from inner pole 13 due to the pressure of restoring spring 23, whereupon first flange 21, being connected to valve needle 3, moves in a direction counter to the lift. Valve needle 3 is thereby moved in the same direction, causing valve-closure member 4 to set down on valve seat surface 6 and fuel injector 1 to be closed.

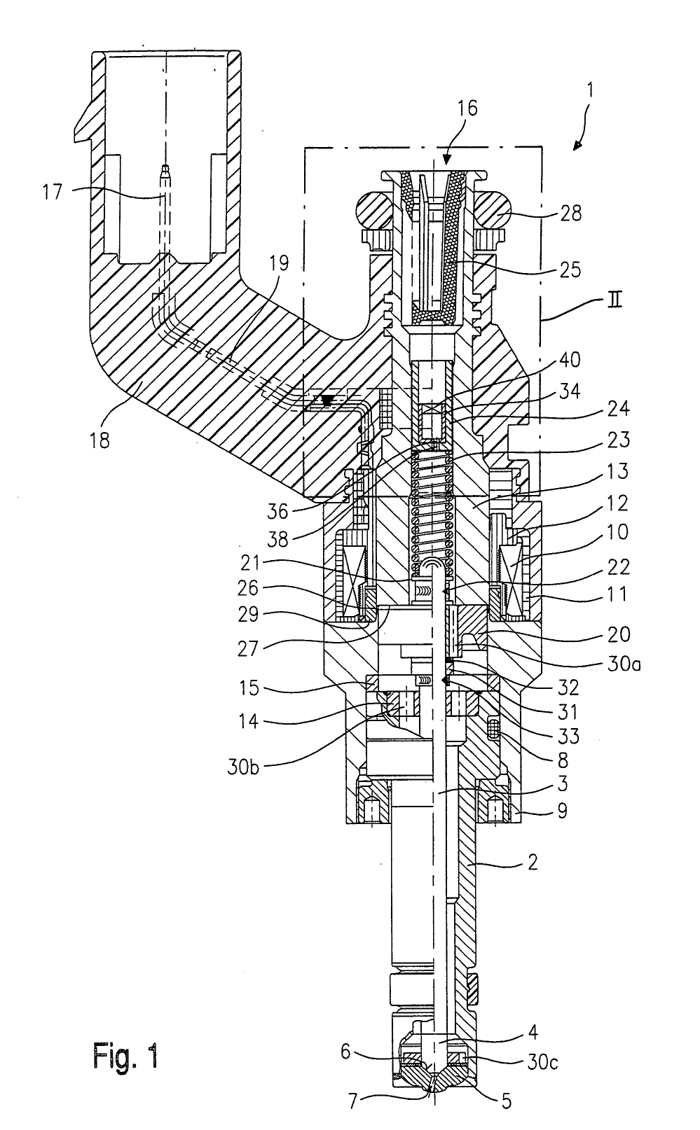

FIG. 2 shows a part-sectional view of the detail, designated II in FIG. 1, of fuel injector 1 designed according to the present invention, without filter element 25 which is located in central fuel supply 16 in FIG. 1.

According to the present invention, adjustment sleeve 24 has a base 37 which is provided with an eccentrically configured bore 38. Positioned in adjustment sleeve 24 is an inner sleeve 34 which likewise has a cup-shaped design and a base 35 in which an eccentric bore 36 is configured. Inner sleeve 34 is dimensioned such that it is able to be affixed in adjustment sleeve 24 with the aid of a spring ring 39. Adjustment sleeve 24 has a slitted, matching design, so as to allow the installation of inner sleeve 34 by spring ring 39. Spring ring 39 ensures that inner sleeve 34 is unable to rotate on its own during operation of fuel injector 1, so that the flow is not modified. The flow rate is correspondingly adjusted, counter to the retention force of spring ring 39.

Eccentric bores 36 and 38 are aligned in bases 35 and 37 in such a way that they have a common axis. Inner sleeve 34 has a working surface 40 for a matching tool, for instance, a polygon, by which inner sleeve 34 is able to be twisted.

Following the preassembly of the components, the dynamic and static flows through fuel injector 1 are adjusted with the aid of adjustment sleeve 24 and inner sleeve 34. For this purpose, adjustment sleeve 24 is first pressed so far into fuel injector 1 that a desired value of the dynamic flow is obtained by an appropriate tension of restoring spring 23.

Subsequently, using the aforementioned tool which engages on working surface 40, inner sleeve 34 is twisted with respect to adjustment sleeve 24 until a diaphragm cross-section 41 is obtained by overlapping eccentric bores 36 and 38, which throttles the static flow rate to a desired value. The static flow rate is variable between an unthrottled value, given complete overlapping of bores 36 and 38, and a minimal value, given a nearly closed diaphragm cross-section 41.

Especially advantageous in the system is the possibility of adjusting the static and the dynamic through-flow through fuel injector 1 independently of one another, so that the afore-described working steps may also be implemented in reverse order.

FIG. 3 shows a cross-section through adjustment sleeve 24 and inner sleeve 34, the section being along the line III-III in FIG. 2.

As already described earlier, the static flow through fuel injector 1 is determined via the resulting diaphragm cross-section 41 of bores 36 and 38 configured in inner sleeve 34 and in adjustment sleeve 24. For the purpose of illustration, and adjustment is shown in FIG. 3 by way of example. Bore 38 of adjustment sleeve 24 is projected into the sectional plane of FIG. 3.

Diaphragm cross-section 41 may be modified at any time by removing filter element 25 from fuel supply 16 and twisting inner sleeve 34 with respect to adjustment sleeve 24 using an appropriate tool. Fuel injector 1 need not be removed in its entirety, nor is it necessary to remove components from fuel injector 1 in order to adjust the flows.

The present invention is not limited to the exemplary embodiments shown and is also suitable, for instance, for fuel injectors 1 having piezoelectric or magnetostrictive actuators.

What is claimed is:

1. A fuel injector (1) for fuel-injection systems of internal combustion engines, especially for the direct injection of fuel into the combustion chamber of an internal combustion engine, comprising an actuator (10); a valve needle (3) which is in operative connection to the actuator (10) and acted upon by a restoring spring (23) in a closing direction, in order to actuate a valve-closure member (4) which forms a sealing seat together with a valve-seat surface (6); and an adjustment sleeve (24), which provides the restoring spring (23) with an initial stress,
wherein the adjustment sleeve (24) is cup-shaped and has a bore (38) in a base (37), which is in variable alignment with a bore (36) in a base (35) of a likewise cup-shaped inner sleeve (34) able to be inserted into the adjustment sleeve (24).

2. The fuel injector as recited in claim 1,
wherein the bores (36, 38) are eccentrically configured in the bases (35, 37).

3. The fuel injector as recited in claim 1 or 2,
wherein the position of the eccentric bores (36, 38) with respect to one another defines a resulting diaphragm cross-section (41).

4. The fuel injector as recited in one of claims 1 through 3,
wherein the inner sleeve (34) is adjustably disposed in the adjustment sleeve (24), so that a fuel quantity flowing through the fuel injector (1) per unit of time is a function of the resulting diaphragm cross-section (41).

5. The fuel injector as recited in one of claims 1 through 4,
wherein the inner sleeve (34) has a working surface (40) for an adjustment tool.

6. The fuel injector as recited in claim 5,
wherein the inner sleeve (34) is able to be twisted in the adjustment sleeve (24) by the adjustment tool.

7. The fuel injector as recited in one of claims 1 through 6,
wherein the inner sleeve (34) is affixed in the adjustment sleeve (24) by a spring ring (39).

8. The fuel injector as recited in one of claims 1 through 7,
wherein the adjustment sleeve (24) is slit.

9. A method for adjusting a fuel injector (1) for fuel-injection systems of internal combustion engines, especially for the direct injection of fuel into a combustion chamber of an internal combustion engine, having an actuator (10), a valve needle (3), which is in operative connection with the actuator (10) and acted upon in a closing direction by a restoring spring (23), to actuate a valve-closure member (4) which forms a sealing seat together with a valve-seat surface (6), and having a sleeve (24) which provides an initial stress to the restoring spring (23), the adjustment sleeve (24) being cup-shaped and including a bore (38) in a base (37), which has a variable alignment with a bore (36) in a base (35) of a likewise cup-shaped inner sleeve (34) able to be inserted into the adjustment sleeve (24), including the following method steps:
adjustment of the static flow rate of the fuel injector 1;
adjustment of the dynamic flow rate of the fuel injector 1.

10. The method as recited in claim 9,
wherein the first method step includes the following partial steps:
measurement of a static instantaneous flow rate of the fuel injector (1);
comparison of the measured instantaneous flow rate to a static setpoint flow rate; and
adjustment the inner sleeve (34) in the adjustment sleeve (24) until the instantaneous flow rate corresponds to the static setpoint flow rate.

11. The method as recited in claim 10,
wherein the inner sleeve (34) is adjusted in the adjustment sleeve (24) by twisting, with the aid of an adjustment tool.

12. The method as recited in one of claims 9 through 11,
wherein the second method step includes the following partial steps:
measurement of a dynamic instantaneous flow rate of the fuel injector (1);
comparison of the measured instantaneous flow rate to a dynamic setpoint flow rate; and
adjustment of the adjustment sleeve (24) of the fuel injector (1) until the instantaneous flow rate corresponds to the dynamic setpoint flow rate.

13. The method as recited in claim 12,
wherein the sleeve (24) is adjusted by sliding, using a tool.

14. The method as recited in one of claims 9 through 13,
wherein the adjustment of the static flow rate by twisting the inner sleeve (34), and the adjustment of the dynamic flow rate by axial sliding of the adjustment sleeve (24) are implemented independently of one another.
